(19) United States
(12) Patent Application Publication
(10) Pub. No.: US 2023/0128878 A1
(43) Pub. Date: Apr. 27, 2023

(54) THREE-DIMENSIONAL CONTENT OPTIMIZATION FOR UNIFORM OBJECT TO OBJECT COMPARISON

(71) Applicant: Illusio, Inc., San Clamente, CA (US)

(72) Inventors: Preston Platt, San Diego, CA (US); Ethan S. Winner, San Clemente, CA (US)

(21) Appl. No.: 17/974,401

(22) Filed: Oct. 26, 2022

Related U.S. Application Data
(60) Provisional application No. 63/272,609, filed on Oct. 27, 2021.
(60) Provisional application No. 63/318,351, filed on Mar. 9, 2022.

(51) Int. Cl. G06T 19/20; G06T 17/20; G06T 15/04; G06F 16/532; G01S 17/89

(52) U.S. Cl. CPC G06T 19/20; G01S 17/89; G06F 16/532; G06T 15/04; G06T 17/20; G06T 2200/04; G06T 2200/08; G06T 2219/2021

(57) ABSTRACT

Disclosed is a configuration for uniform object to object comparison. The configuration captures a three dimensional (3D) scan file and generates a base mesh through an animation platfom. The generation of the base mesh creates a mesh file and a UV texture file. The configuration identifies, from a database, a closest matching base mesh file based on a subject of the 3D scan file. The configuration determines a plurality of points in the 3D scan file and a close matching base mesh file to be placed on key indentifiable vertices of each file respectively. The configuration deforms the base mesh to become an identical representation of the 3D scan and generates a new 3D mesh file and a new UV texture file.

### CROSS REFERENCE

This application claims a benefit of, and priority to, U.S. Pat. Application No. 63/272,609, filed Oct. 27, 2021, and to U.S. Pat. Application No. 63/318,351, filed Mar. 9, 2022, the contents of each of which is incorporated by reference in its entirety.

### TECHNICAL FIELD

The disclosure generally relates to the field of optimizing three-dimensional (3D) content in a uniform capacity to enable highly compressed content that is widely compatible in which the output is also uniform for using object to object data sets for comparison.

### BACKGROUND

The global three-dimensional (3D) scanning market size is estimated to reach $8.04 billion (U.S. Dollars or USD) by 2025. The 3D scanning market is driven by increased research and development spending and advancements in technology. The emergence of structured light technology, counter to the customary laser dot or laser line technology, also is estimated to fuel the market growth.

One of the reasons for this accelerated growth in 3D scanning is the availability of scanning devices available to consumers. For example, smartphones and tablet computers today are enabled to allow for 3D scanning. These devices are equipped with LiDAR sensors, which are used for 3D capture. Photogrammetry software also is readily available which creates 3D images from a series of still photographs taken by, for example, a smart phone or tablet equipped with such sensors.

A problem with captures includes generation and application of 3D meshes. A 3D scan mesh output file is large for integration into other applications that demand a relatively quick automated response time. The output files often are many megabytes and may exceed one gigabyte in size. This inherently makes real time processing something that is difficult to automate and integrate into specific platforms. As meshes are generated using polygons, there are software applications that decimate, or reduce, the number of polygons in an attempt to address this issue. These approaches, however, present additional problems, for example, reducing accuracy of data measurements associated with the 3D scanned object and creating incompatibility for platforms, e.g., rigged characters, physics, measuring, collisions and file size requirements.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A illustrates a process overview for an initial three-dimensional (3D) scan to the final output files that can be used for calculations and implementation into other platforms for 3D environments in accordance with one embodiment.

FIG. 1B illustrates an example set of images of boxes to illustrate by example application of capturing a 3D scan in accordance with one embodiment.

FIG. 2A illustrates an example process for capturing a 3D image scan in accordance with one embodiment.

FIG. 2B illustrates an example object of a cardboard box to illustrate by example application of the capture of a 3D image scan in accordance with one embodiment.

FIG. 3A illustrates an example process for generating a base mesh retopology to create a smart wrap using points in accordance with one embodiment.

FIG. 3B illustrates an example object of a cardboard box to illustrate by example application generating a base mesh retopology to create a smart wrap using points in accordance with one embodiment.

FIG. 4A illustrates a matching process whereby an incoming three-dimensional (3D) scan is automatically aligned with a base mesh in accordance with one embodiment.

FIG. 4B illustrates an example object of a cardboard box to illustrate by example application of an incoming three-dimensional (3D) scan is automatically aligned with a base mesh in accordance with one embodiment.

FIG. 5A illustrates an example process for determining volume measurements in accordance with one embodiment.

FIG. 5B illustrates an example object of a cardboard box to illustrate by example application of a process for determining volume measurements in accordance with one embodiment.

FIG. 6 illustrates an example computing system having some or all the components of a computing system for execution of one or more of the processes described in accordance with one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The disclosure generally relates to the field of optimizing three-dimensional (3D) content in a uniform capacity to enable highly compressed content that is widely compatible. The output provides uniformity for using object to object data sets for comparison. The disclosed configuration identifies objects from a dataset and automatically shrink wraps clean base geometry, to compress a 3D object to a standardized and optimized shape and size.

The disclosed configuration also allows for object recognition in order to quickly and accurately calculate compression and volume of geometremic values without the need for fixed points of reference. By taking a scanned model, the model may be identified by taking vertices points and applying an iterative closet point (ICP) process to identify a predefined base mesh that best matches the original scanned mesh. Once the base mesh is identified, the scanned mesh is placed directly inside of the base mesh to align as closely as possible. After aligning the separate meshes, a shrink wrap process is applied in which the base mesh most relevant points are identified to provide a one-to-one replica of the scanned mesh. The result is a new, close to fully aligned, matched base mesh. The resulting mesh has a defined vertices count and texture space. Next, the configured transfers the texture from the original scanned mesh to the new base mesh to provide an output of texture that is optimized. The newly generated base mesh and associated texture may now be optimized for output to any file type specified. For example, this may be USD, USDZ, GLTF, GLB, FBX, OBJ, and texture files using .JPG for image compression. The result may take an original mesh of 2 million polygons and a 8,000 × 8,000 pixel input and automatically compresses the file to an output of 1,000 polygons with a texture resolution of 1024 × 1024 without any visual difference in the model or texture.

### Proces Overview

The disclosed configuration (system, method, non-transitory computer readable storage medium) creates a usable and integratable three-dimensional (3D) mesh and UV texture from a standard 3D image captured by any 3D camera. The 3D camera may be on a mobile device, e.g., APPLE IPHONE, that includes a LiDar sensor. Examples of other devices to which the principles apply may include a handheld 3D capture device or a 3D image that is a result of a process of photogrammetry.

Referring now to Figure (FIG.) 1A, it illustrates a process overview in which an object is identified for 3D scanning. The object is processed through the platform to render digital files. The digital files may be integrated into other software platforms for manipulation. The disclosed configuration allows for performing tasks that typically require small file sizes, have measurable geometry and UV textures.

By way of example, in one embodiment an object is scanned (or captured) as an image using a device such as an smartphone, e.g., IPHONE, with LiDar sensor. Alternately, an object may be scanned in 3D through a process of photogrammetry which only requires a series of photographs captured through a standard camera on any smartphone or digital camera. The 3D scan produces a digital mesh. This mesh is processed through the proposed methods to be matched with a similar 3D object which has already been created and stored in an accessible database (a base mesh or Base Mesh). The matching process is automated though an artificial intelligence engine. After the scanned 3D mesh is matched with a suitable base mesh from the database, a secondary process deforms the base mesh to match the shape and size of the original 3D mesh. The proposed process generates new files which are nearly identical to the original 3D mesh. These new files have significantly lower file size, identifiable geometry and a separate texture file that has been optimized for manipulation and integration into other platforms.

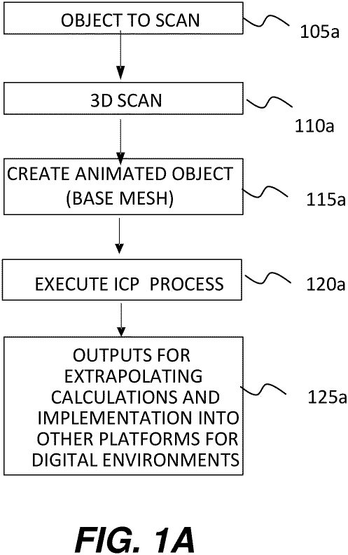

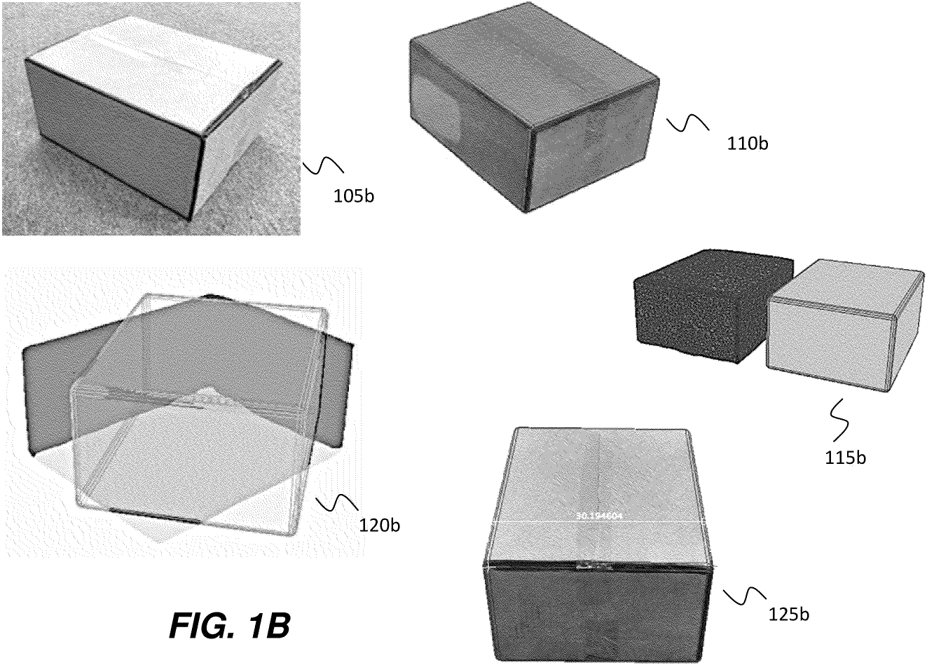

FIG. 1B illustrates an example set of images of a box to illustrate by example application of the process in accordance with one embodiment. The original box is scanned to create a 3D mesh and then matched with a base mesh. That base mesh is then deformed to produce a replica of the orginal mesh; however this new base mesh has properties which are now optimized for integration into platforms that require lower files sizes and are intended to measure and apply algorithms to manipulate the mesh for real time rendering.

Turning now to FIG. 1, the process starts and identifies 105a an object to scan 105. By way of example, FIG. 1B is referenced as a use case in which the the object is a cardboard box 105b. The object, the cardboard box 105b in this example, is scanned 110 by a 3D capture system. In this case the capture device is a mobile device with LiDAR functionality, e.g., an APPLE IPHONE 12 or higher. The original 3D file format was a GLTF file with a 3.3 megabyte file size, e.g., cardboard box 110 in FIG. 1B. There are two components to a 3D file to make it integratable to usable applications: a mesh file and a UV texture file. This means that there are two separate files which are extracted from the original GLTF file.

The disclosed configuration does not require any fixed reference points and the data usage requirements are low enough for speedy load times and requires little memory from the smart phones which are used to capture the initial 3D scans.

As noted, the disclosed configuration leverages (e.g., uses) Light Detection and Ranging (LiDar) sensors, for example, as found within smartphones, e.g., APPLE IPHONE 12 and and higher and tablets, e.g., APPLE IPAD PRO. The disclosed configuration is capable of measuring nearly any geographic landscaping measurement within, for example, one centimeter accuracy.

The native mesh and UV texture files are typically too complex and memory-intensive to be easily integrated into another application. These files work well in a copy and paste situation, but they are inherently difficult to add deformations or other complex changes to the digital representations.

In order to create usable files, the disclosed configuration compresses the native files and creates a new mesh and UV texture files that can be easily manipulated to operate in conjunction with applications other then the original program that created the 3D scanned image file. Specifically, the configuration creates 115a an animated object, referenced as a base mesh. The base meshi is relatively similar in shape and size to the scanned image. In one embodiment, relative shape and size may be qualified as approximately 70% representative of the orginal 3D scan in shape and size. The base mesh may be split into mesh file and a UV texture file. In FIG. 1B, the base mesh of a 3D box 115b may be composed in an animation software application such as MAYA SOFTWARE by AUTOCAD. The base mesh has unified geometry and unified texture so that it can easily operate within applications that are necessary to transform the shape and size of the 3D scanned image.

The the disclosed configuration next executes 120a an ICP (iterative closest points) process to match a 3D scan file with a base mesh. This is an alignment process based on a specified set of points on the original 3D scan file and a corresponding set of points on the base mesh is illustrated with the box 120b in FIG. 1B.

After the 3D scanned image is matched with a base mesh through the ICP process, the proposed process manipulates the shape of the base mesh transforming it into a mirror image of the original 3D scanned image. This process works well regardless of the subject. For example, it could be used for furniture, geological objects, human faces, etc., provided there is a base mesh that is developed and intended to be matched with that subject matter. The base meshes that have been created and stored in a database have unified geometry and unified UV texture 125a.

After the new base mesh of the card board box 125b has been mirrored to the original object 110b, the base mesh file and the UV texture files can now be used to accurately represent the scanned object. These files now have reduced file sizes, polygon counts, and indentifiable geometry and texture. These new base mesh files can be measured for geometry, and the appearance can be easily changed with respect to color, patterns, lighting, sizing, etc. In addition, the files can be applied in an integrated fashion to digital or animation rigs.

In one embodiment, the animation may be generated through a rigging process. The rigging process creates (or generates) a skeleton, e.g., through: blender, maya, 3d max, modo etc.).

### Example Operation

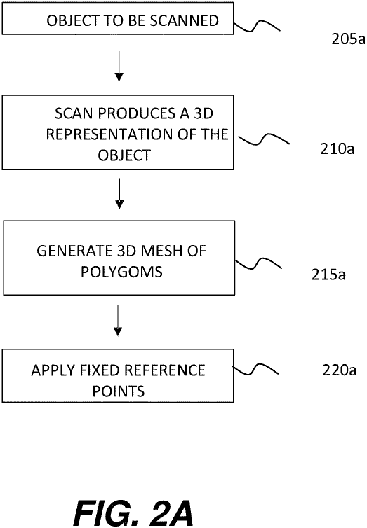

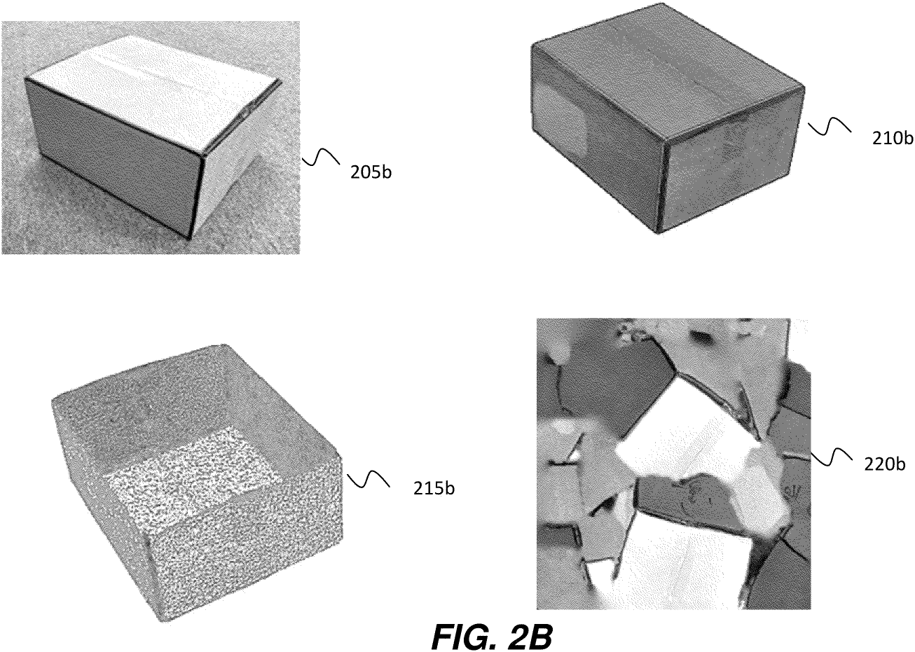

Turning to FIG. 2A, it illustrates an example process for capturing a three-dimensional (3D) drawing scan in accordance with one embodiment. The process starts with an object to be scanned 205a. FIG. 2B illustrates an example object of a cardboard box 205b to illustrate by example application of the capture of a 3D image scan in accordance with one embodiment.

The process scan produces 210a a 3D representation of the object. In FIG. 2B, a cardboard box 210b (i.e., the physical object) is illustrated. The scan may be received using a camera on a device that includes a LiDAR sensor, e.g., a smartphone, a tablet or an action camera. This device may be referenced as a user device. The 3D scan may be captured by moving the LiDAR device around the object that is to be captured and presented in full three-dimensions. With a LiDAR scan, all three dimensions of the object are captured.

Using the received scan, the process produces (or generates) a mesh and a UV texture corresponding to the scanned object (FIG. 210). The generated mesh data is composed of randomized points corresponding to the contours of the scanned object.

The process generates a 3D mesh comprised of polygons. The 3D meshes use reference points in X, Y and Z axes as shown through a cardboard box 215b in FIG. 2B. The mesh is not optimized for manipulation as there is no way to discern the individual points of the mesh of the cardboard box 215b in FIG. 2B.

The UV texture file that is generated is composed of randomized texture data that only corresponds to the native mesh file. It may not be optimized (or packed) for manipulation or placement on animation rigs or within conditions for real time rendering by applying 220a UV texture wraps. The addition of unified geometry and unified UV textures would allow for extrapolate relevant geometric data from native files. Further, unified geometry and unified UV textures would allow for deformations or alterations to be applied. The original cardboard box 220b in FIG. 2B illustrates a 3D scan file that is not optimized for precise measurements or for and automated manipulation process.

The captured image may be stored in an account profile on a local device and/or a server. The provided account may have a unique identifier and may comprise multiple files linked to that identifier and/or may be entered into a provided database where the profile may be augmented.

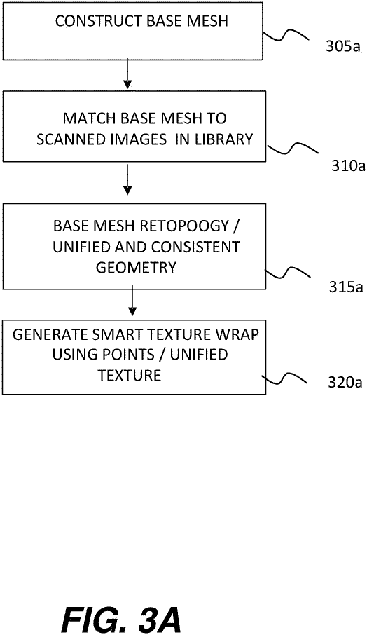

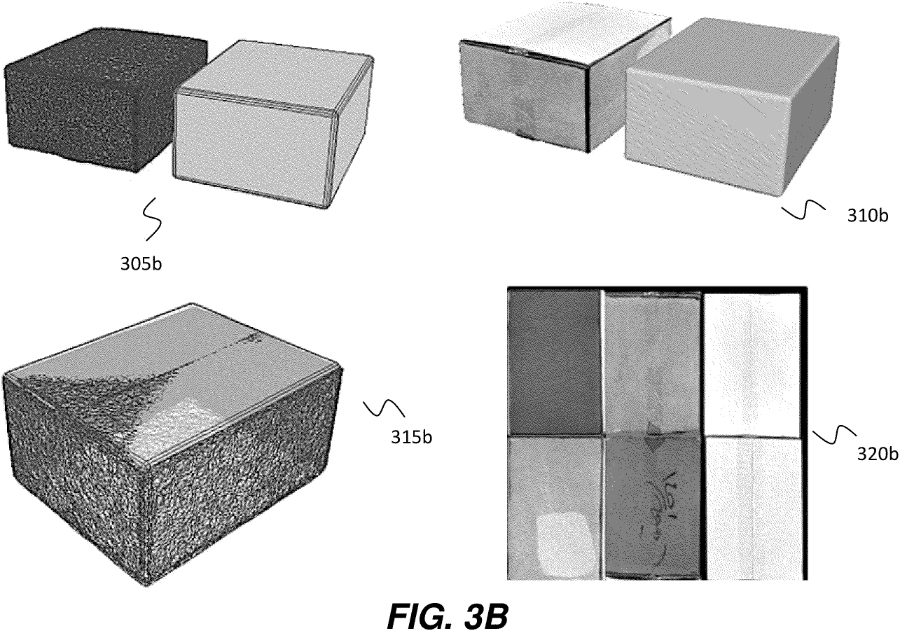

Referring now to FIG. 3A, it illustrates an example process for generating a base mesh retopology to create a new mesh file and UV texture file with unified geometry and unified UV texture, respectively, in accordance with one embodiment. FIG. 3B illustrates an example object of a cardboard box to illustrate by example application generating a base mesh retopology that has clean and identifiable geometry and a unified UV texture file with which one can apply a smart wrap using points in accordance with one embodiment.

The proposed process of generating a new base mesh simplifies the topology of the original high definition captured image. It is the base mesh that encapsulates unified geometry that is in turn utilized to extrapolate geometric measurements and applied for potential deformations. This base mesh has unified geometry and predetermined boundaries that are utilized to align vertices from which volumetric measurements can be calculated. The newly created base mesh generates a unique mesh file as well as a unique UV texture file.

The process starts with the construction of a 305a a base mesh, e.g., using animation software such as MAYA from AUTODESK. This base mesh if created by a developer and is required in order for the proposed process to be fully executed; however the creation of the base mesh is not a component of the process itself. The native base mesh file is composed in an animation software application such as Maya from AutoDesk. The cardboard box 305b in FIG. 3B shows a base mesh of the physical cardboard box object. The base mesh may be reduced to an optimal file size.

A library of base meshes, e.g., stored in a database of a storage, may be used to match 310a against a 3D scan that is being processed through the platform.. The base meshes only need to be approximations of the shape of the 3D scanned image. The mesh of the cardboard box 310b in FIG. 3B shows a matching base mesh of a similar card board box that has already been generated and stored in the database.

A unified geometry and unified UV texture is applied 315a to the base mesh retopology with a low polygon count and low file size. For example, the base mesh could have 250 polygons with a texture resolution of 1024 × 1024 without any visual difference in the model or texture compared with original 3D scanned files that has a polygon count in the thousands. The cardboard box 315b in FIG. 3B illustrates the base mesh retopology with unified and consistent geometry and demonstrates how it replicates the shape and size dimensios of the original 3D scan.. This base mesh has geometric properties and spatial relations unaffected by the continuous change of shape or size of figures.

The process generates 320a a smart mesh. Specifically, the base mesh file has unified geometry which conforms to any animation script or rigging applications.

The process also generates a new UV texture file with unified texture that is optimized for the capability to modify the texture in color, lighting, patterns, textures, etc. as shown with the cardboard box 325b in FIG. 3B.

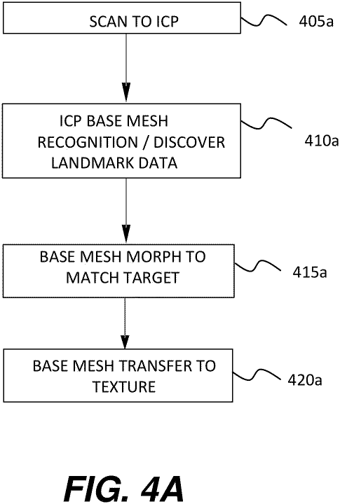

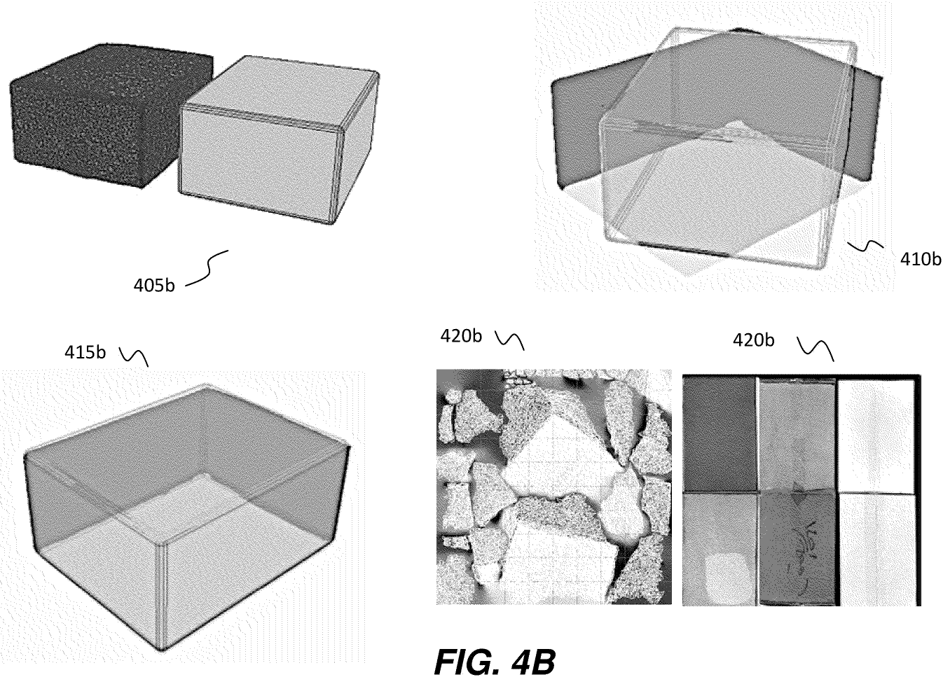

FIG. 4A illustrates a matching process whereby an incoming three-dimensional (3D) scan is automatically aligned with a base mesh in accordance with one embodiment. The base mesh may be stored in an existing database. FIG. 4B illustrates an example object of a cardboard box to illustrate by example application of an incoming three-dimensional (3D) scan is automatically aligned with a base mesh in accordance with one embodiment.

A repository of base meshes, which is stored on the backend server, represents different shapes and sizes of a given object. Each base mesh represents a different shape and sized box (in this use case) that align with variances that you would find in a sample population of boxes. In the disclosed configuration, once a 3D scan that has been captured with the LiDAR sensor, the platform automatically assigns points to the scan and matches these points against fixed points on the base mesh. This process utilizes interative closest points (ICP), which is mainstream algorithm used in the process of accurate registration of 3D point cloud data.

The disclosed process is programmed to find the closest matching base mesh which has a similar shape and size to the captured 3D scan. Once a closest match is identified in the database that match may be stored with the account profile, e.g., as a reference link or as a copy of the matched file.

The disclosed process applies automatic deformations the base mesh to replicate the sahe and size of the scanned 3D image. This newly created base mesh generates a new mesh file and a new UV texture file that can represent the native 3D scanned image for purposes of geometric calculations and visual outputs. These files also may be integrated into other platforms for the purposes of modifications and real time renderings.

In FIG. 4A, a scan 405a to interative closest points (ICP) is conducted. This process is a points assignment process which enables the platfom to identify location specific data of the 3D scan in order to match it with the points on a base mesh which has already been created and is stored on the database. An incoming 3D scan of a cardboard box, e.g., 405b is FIG. 4B, is assigned location points through the ICP process. The location points are stored with the account profile. The location points are used to match the cardboard box with the closest matching base mesh based on the relative points on that specific base mesh. The base mesh does not need to be an exact representation of the incoming 3D scan. Accordingly, the system applies deformations to the base mesh to alter the shape and size to replicate the incoming 3D scan as closely as possible. These deformations are made on the backend server side of the platform. All base meshes are generated with a set number of polygons and vertices, so that as the base mesh is altered, the math remains constant and the platform is able to calculate measurements with or near one centimeter of accuracy. The points corresponding to best fit with the base mesh are stored with the account profile.

In some instances, automatic alignment using ICP is not effective or needs extra support in identifying the scan visual data (texture data) that has key identifiers. For example, this may be the outline of a cardboard box or a specific body part in the case of matching human forms, which can be used to assist in correcting the matching process. In this case using visual computer vision techniques, such as width, length and height is utilized and then these characteristics are used to identify the most appropriate base mesh.

The process identifies a 415a base mesh to match against the 3D scan of the cardboard box, either through a manual or an automatic process. The identified points may be utilized in a methodology of apply deformations to the base mesh to accurately replicate the shape and size of the original 3D scan. Due to the fact that the base mesh has unified geometry, the newly generated file with applied deformations also has intact unified geometry. Application of the shrink wrap enables a system to apply unified and measurable geometry to an otherwise random and dense mesh. This process takes into consideration the points shown as key points to stretch the skin from the base mesh to match the shape and form of the scanned mesh to perfectly align the two meshes. The cardboard box 415b in FIG. 4B shows the morphed base mesh to the target. Without this process there would be accuracy inconsistency. By using this technique, the disclosed methodology has generated a new bash mesh file 420b and a new UV textire file 425b.

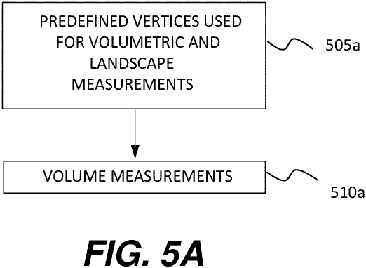

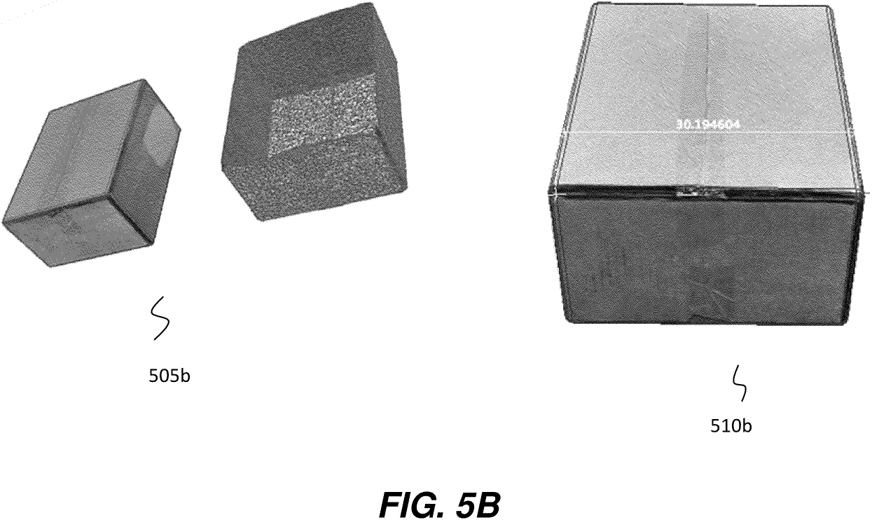

FIG. 5A illustrates an example process of generating a new retopologized mesh and UV texture file. The mesh file has unified geometry which means that meaurements can now be calculated within 1 mm accuracy. FIG. 5B illustrates an example object of a cardboard box to illustrate by example application of a process for determining volume measurements in accordance with one embodiment. The process may be utilized to understand and extrapolate exact vertice counts, linear geometry and volume calculations.

The vertices count on the new base mesh 510b were originally established on the base mesh 505b prior to deformations. Distinct points were also identified which will be used for measurement calculations. The number of vertices and the geometry remain constant through the proposed process of applied deformations and in turn are measurable in order to extrapolate linear and volume-based measurements. Specifically, the process applies 505a predetermined vertice points for volumetric and landscape measurements. As the platform deforms the original base mesh, the polygons and vertices are rearranged in a manner with applied geometry. The process utilizes points-based algorithms to render realtime calculations. A methodology of this would be ICP or iterative closet point calculations. For example, in the use case of a woman’s torso, the measurements are applied independently to the left and right breast. The calculated vertices are stored with the account profile.

In the disclosed process, linear and arced measurements can be extrapolated and shown on a screen display over the actual image. Such as the distances in length, width and heighth on the cardboard box. If the subject matter was a women’s breasts, the left nipple to the right nipple or the distance from the clavicular notch to the left nipple could be identified. These measurements are processed on the backend server and are exported through APIs (Application Programming Interface) to a database that is intended to be integrated with ancillary applications such as printing applications or apparel sizing and sorting databases in order to make recommendations on sizing to the customer.

In the use case of female breasts, the disclosed method could identify measurements of the distance between the clavicular notch and the nipple, the left nipple to the right nipple and the inframmory fold of each breast to the respective nipple. These are sample measurements and additional measurements can be calculated including volume measurements.

In FIG. 5B, the cardboard box 505b is shown where there is a transfer of texture to unified geometry for the ame UV sets with transfer texture. For example, the process of projecting the texture onto a new UV coordinate space. Here, the system may be configured to use the same points that the selection process uses to match the relative distances, which provide a best mesh as a selected Base Mesh. Hence, it is deformed to fit as precisely as possible to the scanned geometry. By doing this process texture back may be projected onto the 3D geometry with the new UV set comprised of new 2D UV coordinates to have one single texture that matches to the texture of the previous models. The new UV set is pre setup on the Base Meshes. All unifying the look of the way the texture is splayed out, or spread, on a 0 - 1 scale. That is, the image is “cut” so that it may be flattened for viewing and for calculating correct measurments.

Referring back to FIG. 5A, the process analyzed volume measurements 510a. As shown in FIG. 5b, the cardboard box 510b is illustrated with an area that is defined by linearly connecting vertices in order to calculate volume. The platform automatically assigns the appropriate vertices for this calculation based on the predetermined specifications of the base mesh. It is possible to redefine which vertices should be used for this calculation based on the objective of the volume measurement criteria. In the use case depicted in this illustration, the objective was to calculate the total volume of the cardboard box. To this end, the backend server has been programmed to identify the relevant vertices necessary to establish this calculation.

### Computing Machine Architecture

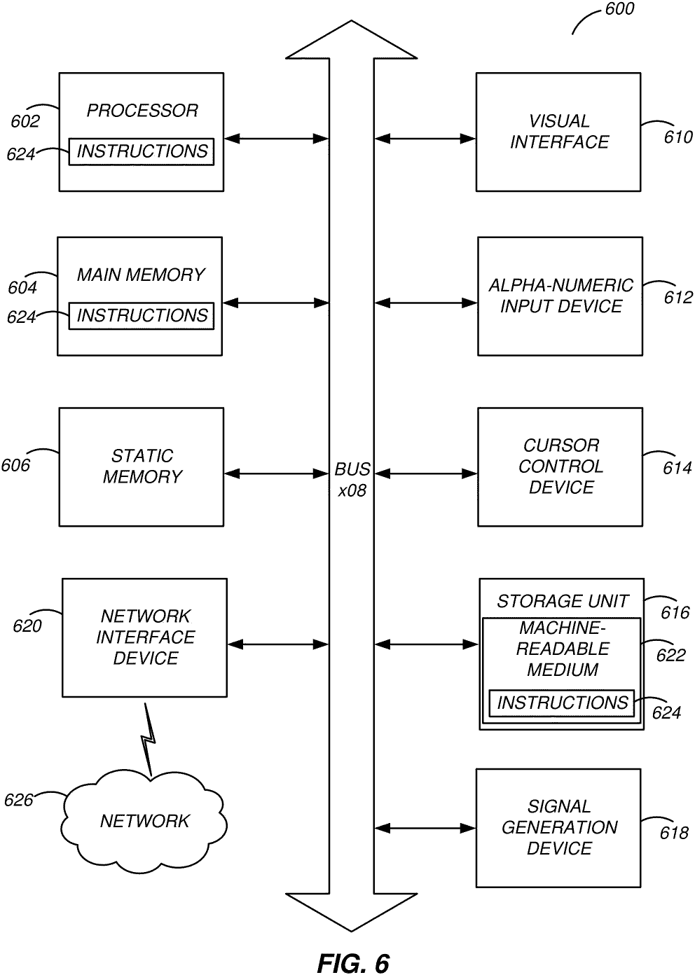

FIG. (Figure) 6 is a block diagram illustrating components of an example machine able to read instructions from a machine-readable medium and execute them in a processor (or controller). Specifically, FIG. 6 shows a diagrammatic representation of a machine in the example form of a computer system 600 within which program code (e.g., software) for causing the machine to perform (or execute) the processing described. The program code may be comprised of instructions 624 executable by one or more processors 602. For example, the image processing techniques described above may configure the one or more processors to operate in a the specific manner to produce the results of the described methods.

In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 624 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 600 includes one or more processors 602 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 604, and a static memory 606, which are configured to communicate with each other via a bus 608. The computer system 600 may further include visual display interface 610. The visual interface may include a software driver that enables (or provide) user interfaces to render on a screen either directly or indirectly. The visual interface 610 may interface with a touch enabled screen. The computer system 600 may also include input devices 612 (e.g., a keyboard a mouse), a storage unit 616, a signal generation device 618 (e.g., a microphone and/or speaker), and a network interface device 620, which also are configured to communicate via the bus 608.

The storage unit 616 includes a machine-readable medium 622 (e.g., magnetic disk or solid-state memory) on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor’s cache memory) during execution.

### Additional Configuration Considerations

There is lacking applications that integrate 3D scanning into consumer-based applications with a seamless and real-time transition between 3D capture and utilization.

Additionally, it is critical to have a solution that is user-friendly and does involve necessary steps which could result in a dropoff from utilization. One such common requirement is the need to scan additional fixed points of reference adjacent or overlapping with the scanned object. One such example is the need to scan or take a photograph of a mobile phone held next to the scanned object whereby the dimensions of the mobile phone are used as fixed measurements which serve as a basis for calculating the measurements for of the primary subject.

Another use case is in the scanning of piles of dirt on a construction site. In this example, the need to place orange cones alongside the pile in a measured placement to serve as fixed points of reference for measuring the pile. This adds a layer of potential error due to improper placement of the cones which would result in erroneous measurements of the pile.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for breast implant image visualization and selection through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for uniform object to object comparison comprising:
receiving a three dimensional (3D) scan file;
identifying, from a database, a closest matching base mesh file based on a subject of the 3D scan file;
determining a plurality of points in the 3D scan file and the close matching base mesh file, the plurality of points to be placed on key indentifiable vertices of each file respectively;
deforming the base mesh to become an identical representation of the 3D scan; and
generating a new 3D mesh file and a new UV texture file.

2. The method of claim 1, wherein the closest matching base mesh has a predetermined polygon count, a unified geometry and a unified texture.

3. The method of claim 1, wherein the 3D scan file is captured through a 3D capture device.

4. The method of claim 3, wherein the 3D capture device is a smartphone with a LiDAR sensor.

5. The method of claim 3, wherein the 3D capture device is a tablet computer with a LiDAR sensor.

6. The method of claim 1, wherein the 3D scan file is captured through a software platform that utilizes photogrammertry.

7. The method of claim 1, wherein receiving the 3D image file comprises retrieving the 3D image file from a storage medium.

8. A non-tranistory computer readable storage medium comprising stored insturctions for uniform object to object comparison, the instructions when executed causes at least one processor to:
receive a three dimensional (3D) scan file;
receive an original mesh file and a UV texture file;
identify, from a database, a closest matching base mesh file based on a subject of the 3D scan file;
determine a plurality of points in the 3D scan file and the close matching base mesh file to be placed on key indentifiable vertices of each file respectively;
deform the original base mesh to become an identical representation of the 3D scan; and
generate a new 3D mesh file and a new UV texture file.

9. The non-tranistory computer readable storage medium of claim 8, wherein the deformed base mesh has a predetermined polygon count, a unified geometry and a unified texture relative to the closest matching base mesh.

10. The non-tranistory computer readable storage medium of claim 8, wherein the 3D scan file is captured through a 3D capture device.

11. The non-tranistory computer readable storage medium of claim 10, wherein the 3D capture device is a smartphone with a LiDAR sensor.

12. The non-tranistory computer readable storage medium of claim 10, wherein the 3D capture device is a tablet computer with a LiDAR sensor.

13. The non-tranistory computer readable storage medium of claim 8, wherein the 3D scan file is captured through a software platform that utilizes photogrammertry.

14. The non-tranistory computer readable storage medium of claim 8, wherein instructions to receive the 3D image file further comprising instructions that when executed by the at least one processor causes the processor to receive the 3D image file from a storage medium.
